(19) United States
(12) Patent Application Publication
(10) Pub. No.: US 2009/0252195 A1
(43) Pub. Date: Oct. 8, 2009

(54) THERMOMETER PROVIDED WITH PROTECTIVE CASE

(75) Inventor: Salomon Scharer, Meilen (CH)

Correspondence Address: YOUNG & THOMPSON, 209 Madison Street, Suite 500, ALEXANDRIA, VA, 22314, US

(73) Assignee: Artsana S.P.A., Grandate (COMO) (IT)

(21) Appl. No.: 11/721,850

(22) PCT Filed: Apr. 27, 2005
(86) PCT No.: PCT/EP2005/051902

§ 371 Date: Jun. 15, 2007

(30) Foreign Application Priority Data
Dec. 15, 2004 (CH) 02075/04

(51) Int. Cl. G01K 1/08; G01J 5/04

(52) U.S. Cl. 374/121; 374/208; 374/E01.011

(57) ABSTRACT

A remote or contact measurement thermometer, in particular an infrared thermometer, includes an enclosure presenting a measurement portion by which a patient's body temperature is measured, and a display portion through which the temperature can be read. The enclosure is rigid with a case movable relative thereto about an axis of rotation passing through the enclosure, the case being able to assume two working positions relative to the enclosure (2), in a first of these positions the measurement portion (3) being external to the case (26) and in the second of which this latter covers the portion (3), the case (26) presenting an aperture (30) through which the display portion (4) can be accessed visually when the case is in its first working position.

The present invention relates to a thermometer for the remote or contact sensing of a patients body temperature, in particular an infrared thermometer, in accordance with the introduction to the main claim.

A thermometer of the aforesaid type is known to comprise an enclosure presenting a measurement portion through which said temperature is measured. In known manner, this measurement portion comprises a window behind which the infrared sensor is present within the enclosure.

Said enclosure also presents a display portion, of more or less large extension, on which the measured temperature can be read. This display portion generally comprises a display on which said temperature appears, and on which other data or information can advantageously appear regarding the thermometer operation (for example, the charge level of the battery with which the thermometer is provided, an indication that the thermometer is ready for temperature reading, etc.).

The enclosure also comprises an activation pushbutton and, preferably, a surface portion shaped to facilitate its gripping.

Known thermometers of the aforesaid type usually have said enclosure disposed in a case from which said enclosure must necessarily be extracted and separated to proceed to temperature measurement. The fact that the case is completely separate from said enclosure may lead to this latter not being immediately replaced in the case after use, making it possible that the measurement portion of the enclosure suffers impact (with obvious consequences for the infrared sensor) or that dust deposits on the measurement portion, which could interfere with the temperature measurement.

An object of the present invention is therefore to provide a thermometer for the remote or contact measurement of temperature, for example an infrared thermometer, which can be easily and rapidly protected against impacts, moisture, dust or the like after use.

Another object is to provide a thermometer of the stated type the use of which is in any event functional.

Another object is to provide a thermometer of the stated type which is of simple construction and low cost.

These and other objects which will be apparent to the expert of the art are attained by a thermometer in accordance with the accompanying claims.

The present invention will be more apparent from the accompanying drawing, which is provided by way of non-limiting example, and in which:

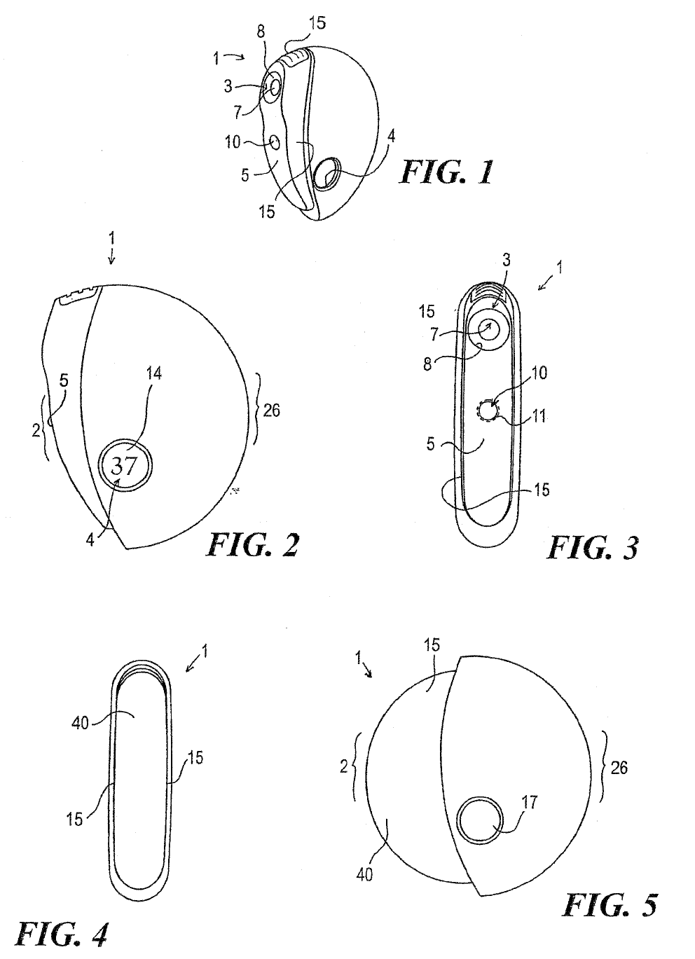

FIG. 1 is a perspective view of a thermometer of the invention in a first working position;

FIG. 2 is a side view of the thermometer of FIG. 1;

FIG. 3 is a front view of the thermometer of FIG. 1;

FIG. 4 is a side view of the thermometer of FIG. 1 in a second working position;

FIG. 5 is a front view of the thermometer of FIG. 4;

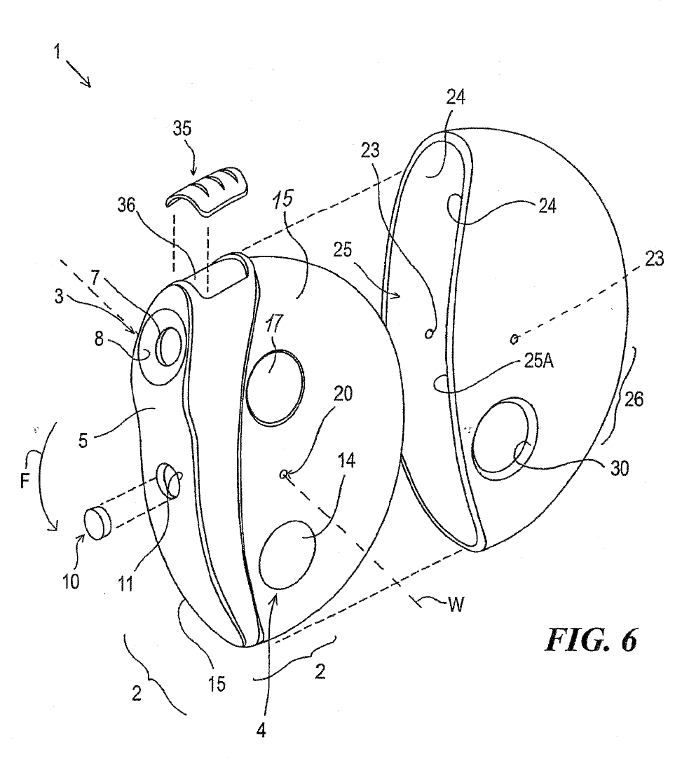

FIG. 6 is an exploded perspective view of the thermometer of FIG. 1; and

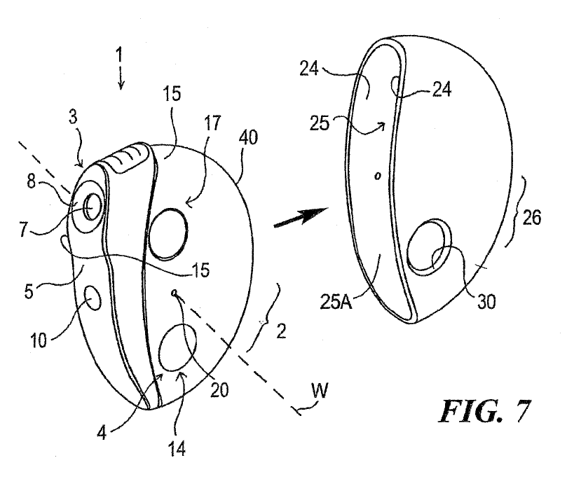

FIG. 7 is an exploded view of the thermometer of FIG. 1 but with components more fully assembled.

With reference to said figures a thermometer is indicated overall by 1. It comprises an enclosure 2 presenting a measurement portion 3 and a display portion 4. Said enclosure 2 has a partly disc-like shape and presents a substantially flat face 5 on which the measurement portion 3 is present. This face 5 is considered the front face of the thermometer, to be held facing the surface, either at a distance therefrom or in contact therewith, of the body of a patient whose temperature is to be measured.

The measurement portion presents a window 7 positioned in correspondence with the frontal flat face 5, said window being located over an infrared sensor inserted in the interior of the enclosure 2. A pushbutton 10 for activating the thermometer is present on the face 5, said pushbutton being movable within a seat 11 provided in said face 5, to cooperate with a usual electrical/electronic circuit associated with the infrared sensor and inserted in the enclosure 2.

On at least one of the lateral faces 15 of said enclosure 2 the display portion 4 is present, presenting a display member 14, for example a liquid crystal screen.

At least the patient's temperature is displayed on this display member after its measurement. On the lateral face 15 another display element 17 is also present showing a publicity characteristic or the like for the thermometer 1.

Projections 20 preferably of conical or frusto-conical shape disposed along one and the same axis W project from the opposing lateral faces 15 of the enclosure 2 to be inserted, advantageously by snap-fitting, into the seats 23 provided in side walls 24 bounding a cavity 25, open at 25A, of a case 26, to permanently connect it to the enclosure 2. In side view, this case has a semi-discoid shape and is able to contain a portion of the thermometer 1 in either of its working positions.

The dual solution is also possible in which the results are present on the walls 24 inside the case cavity 25, and the seats are provided in the faces 15 of the enclosure 2, said seats extending along the axis W.

A hole 30 is provided in one of the walls 24 of the case 26 to overlie the display member 14 when the enclosure 2 of the thermometer 1 is in a first working position in which the measurement portion is external to the case 26 and a patient's temperature can be measured. In contrast, when the enclosure 2 of the thermometer 1 is in its second working position, in which the measurement portion 3 is inserted in the case 26, the display element 17 lies behind the hole 30.

Passage of the enclosure 2 from its first working position to its second working position is achieved by rotating it relative to the case 26 about the axis W (arrow F of FIG. 6). This rotation is facilitated by the presence of a gripping element 35 located in a seat 36 of the enclosure 2, said seat being positioned at one end of the enclosure in proximity to its flat face 5.

The use of the invention is apparent from the description and from the accompanying figures. By virtue of the invention, the thermometer 1 can be easily protected by the case 26 after every use. When not in use, those parts of greater sensitivity (measurement portion 3, display portion 4 and pushbutton 10) lie inside the case 26 with only a part 40 of said enclosure 2 projecting from it. This part 40 has a rounded shape so that the combined thermometer 1 and case 26 define a substantially discoid body easily housed in a drawer, cabinet or the like.

An embodiment has been described in which the thermometer and case, when in the assembled configuration, have a discoid shape. However the text also includes any solution in which a thermometer cooperates with a case which can be moved relative to its enclosure, the combination constituting or defining a cylindrical, elliptical or other solid form. The present text also includes a solution in which the pushbutton 10 is replaced by a microswitch, which is automatically activated to activate the thermometer when the case of this latter passes from the second working position to the first position in which the measurement portion is outside the case. This solution facilitates both personal temperature measurement and temperature measurement of a third person.

1-12. (canceled)

13. A remote or contact measurement thermometer (1), in particular an infrared thermometer, comprising an enclosure (2) presenting a measurement portion (3) by which a patient's body temperature is measured, and a display portion (4) through which said temperature can be read, the enclosure (2) being rigid with a case (26) movable relative thereto about an axis of rotation (W) passing through said enclosure (2), said case (26) being able to assume two working positions relative to said enclosure (2), in a first of these positions said measurement portion (3) being external to the case (26) and in the second of which this latter covers the portion (3), characterised in that said case (26) presents an aperture (30) through which the display portion (4) can be accessed visually only when said case is in its first working position while when the latter is in its second working position said display portion is under the case, said display portion (4) being positioned on a lateral face (15) of the thermometer enclosure (2), said enclosure (2) having a partially discoid shape and presenting a substantially flat face (5) joined to the lateral faces (15), these latter being joined to a rounded part (40) of curvilinear shape, the case presenting a semi-discoid shape and comprising opposing side walls (24) bounding a cavity (25) in which the thermometer enclosure (2) is at least partly disposed, said enclosure (2) being relatively movable within said cavity (25), in one of said side walls (24) of the case (26) an aperture (30) being present at which at least the display portion (4) appears when the thermometer enclosure (2) is in its first working position.

14. A thermometer as claimed in claim 13, characterised in that said axis (W) is defined by at least one projection (20) rising from one of the opposing lateral faces (15) of said enclosure (2), said projections being located along said axis.

15. A thermometer as claimed in claim 13, characterised in that the measurement portion (3) is positioned on the flat face (5).

16. A thermometer as claimed in claim 13, characterised in that a pushbutton (10) for activating the thermometer (1) is present on said flat face (5).

17. A thermometer as claimed in claim 13, characterised in that seats (23) for the projections (20) rising from the thermometer enclosure (2) are present in the side walls (24), at least in correspondence with the cavity (25) of the case (26).

18. A thermometer as claimed in claim 13, characterised in that a projection juts from at least one of the side walls (24), to cooperate with a corresponding seat provided in one of the opposing faces (15) of the thermometer enclosure (2), said seat being disposed along the axis of rotation (W) of the case.

19. A thermometer as claimed in claim 13, characterised in that its enclosure (2) comprises a gripping element (35) for moving it relative to the case (26) about the axis (W).

20. A thermometer as claimed in claim 13, characterised in that its enclosure (2) presents a microswitch cooperating with the case (26), said microswitch activating the thermometer when said case passes from the second working position to the first working position.
